(19) United States
(12) Patent Application Publication
(10) Pub. No.: US 2022/0204318 A1
(43) Pub. Date: Jun. 30, 2022

(54) PUMP MOUNTING FRAME

(71) Applicant: Edwards Vacuum LLC, Sanborn, NY (US)

(72) Inventors: Gregory Ryan Le Mon, Hillsboro, OR (US); Jeffrey Robert Schwab, Hillsboro, OR (US); Mark Kollin Romeo, Hillsboro, OR (US); Jacob Henry Goeke, Hillsboro, OR (US); Ethan Patrick Gundlach, Sanborn, NY (US)

(21) Appl. No.: 17/610,412

(22) PCT Filed: May 15, 2020
(86) PCT No.: PCT/IB2020/054603

§ 371 Date: Nov. 10, 2021

(30) Foreign Application Priority Data
May 17, 2019 (GB) 1906952.5

(51) Int. Cl. B66C 1/62; F16M 11/04

(52) U.S. Cl. CPC B66C 1/62; F16M 11/041

(57) ABSTRACT

A pump mounting frame comprising a latching device for releasably mounting a pump apparatus. The latching device has a body portion having a latch aperture for receiving a latch pin; and a latching member for releasably retaining the latch pin in the latch aperture. The latching member is movable between a closed position and an open position. The latching member has a first arm for retaining the latch pin in the latch aperture when the latching member is in the closed position. The latching member has a second arm for biasing the latch pin out of the latch aperture when the latching member is displaced from the closed position to the open position. The present disclosure also relates to a method of moving one or more pumps using the pump mounting frame.

This application is a national stage entry under 35 U.S.C. § 371 of International Application No. PCT/IB2020/054603, filed May 15, 2020, which claims the benefit of GB Application No. 1906952.5, filed May 17, 2019, the entire contents of each of which are incorporated herein by reference.

### TECHNICAL FIELD

The present disclosure relates to a pump mounting frame. Aspects of the disclosure relate to a pump mounting frame comprising a latching device and a method of moving one or more pumps.

### BACKGROUND

It is known to restrain a vacuum pump using threaded fasteners which attach the pump apparatus to a pump frame. Tooling is required to operate the threaded fasteners. It has been recognised that this may extend the time required to install and remove the pump apparatus. This may prolong maintenance operations which may adversely affect operational efficiency.

It is an aim of the present disclosure to address one or more of the disadvantages associated with the prior art.

### SUMMARY

Aspects and examples of the disclosure provide a pump mounting frame and a method of moving one or more pumps as claimed in the appended claims.

According to an aspect of the present disclosure there is provided a pump mounting frame comprising a latching device for releasably mounting a pump apparatus, the latching device comprising:

a body portion having a latch aperture for receiving a latch pin; and

a latching member for releasably retaining the latch pin in the latch aperture, the latching member being movable between a closed position and an open position;

wherein the latching member comprises a first arm for retaining the latch pin in the latch aperture when the latching member is in the closed position; and a second arm for biasing the latch pin out of the latch aperture when the latching member is displaced from the closed position to the open position. The latch aperture is at least partially closed when the latching member is in the closed position. The first arm may, for example, extend at least partway across an opening of the latch aperture. The latch pin may be retained in the latch aperture when the latching member is in the closed position. The latch aperture is at least partially open when the latching member is in the open position. The latch pin may travel out of the latch aperture when the latching member is in the open position. The latching member is operable to latch and unlatch the latch pin.

The latching device may form part of a frame for mounting a pump apparatus. The frame in this application may be referred to as a pump frame. The pump apparatus may, for example, comprise a vacuum pump. At least in certain examples, the latching device may securely attach the pump apparatus to the pump frame. The pump apparatus may comprise a sub-frame. The sub-frame may be formed integrally with the pump apparatus, for example integrated with a pump housing. The pump apparatus may be supported on wheels or a roller arrangement to facilitate movement. The pump apparatus may be rolled into alignment with the pump frame and the latching device operated to secure the pump apparatus in position. When the latching member is in the closed position, movement of the pump apparatus back and forth relative to the pump frame may be at least substantially prevented.

At least in certain examples, the latching device does not require a tool to operate. The latching device according to the present disclosure may facilitate installation, removal and/or maintenance of the pump apparatus. By providing a toolless mounting arrangement, the installation and removal of the pump apparatus is facilitated. At least in certain examples, the connection(s) may be performed by hand without additional tooling requirements.

The second arm may be configured to displace the latching member to the closed position when the latch pin is inserted into the latch aperture. The latch pin may cooperate with the second arm to displace the latching member.

The second arm may be configured at least partially to project into the latch aperture when the latching member is in the open position. The second arm may, for example, extend into the latch aperture to cooperate with the latch pin. The second arm may be displaced out of the latch aperture when the latching member is in the closed position. The second arm may bias the latch pin out of the latch aperture when the latching member is displaced to the open position.

The latching member may be pivotally mounted. The latching member may pivot between the closed position and the open position. The latching member may be pivotable about a pivot axis. The first and second arms may be provided on opposing sides of the pivot axis.

The latching device may comprise a guide means for aligning the latch pin with the latching device. The guide means may comprise a guide aperture for cooperating with the latch pin. Alternatively, or in addition, the guide means may comprise a guide member for cooperating with the latch pin.

The guide means may operate also to limit or prevent movement of the latch pin relative to the latching device. For example, the guide means may limit lateral and/or rotational movement of the latch pin relative to the latching device.

According to a further aspect of the present disclosure there is provided a latching device for releasably mounting a pump apparatus, the latching device comprising:

a body portion having a latch aperture for receiving a latch pin;

a latching member for releasably retaining the latch pin in the latch aperture, the latching member being movable between a closed position and an open position;

and a guide means for aligning the latch pin with the latching device.

The guide means may comprise a guide aperture for cooperating with the latch pin. The guide aperture may, for example, comprise a cut-out or a recess. The latch pin may locate in the guide aperture. The latch pin may engage a side of the guide aperture to align the latch pin with the latching device.

Alternatively, or in addition, the guide means may comprise a guide member for cooperating with the latch pin.

The guide means may operate also to limit or prevent movement of the latch pin relative to the latching device. For example, the guide means may limit lateral or rotational movement of the latch pin relative to the latching device.

The latching member may be movable in a plane. The guide aperture may have a centreline at least substantially aligned with the plane. The guide aperture may be symmetrical about the centreline.

The guide aperture may have a tapered profile. The taper may be aligned with the latch aperture.

The latch pin may comprise an eye bolt. The eye bolt may have an aperture formed therein, for example in the form of a through hole. The body portion of the latching device may comprise a projection for extending through the aperture. The projection may locate in the aperture when the latching device is latched. The projection and the aperture may cooperate to limit or prevent lateral and/or vertical movement. The aperture may be formed in a head portion of the eye bolt. The head portion may be annular.

The latch pin may comprise a collar for aligning the latch pin with the latching device. At least in certain examples, the collar may be disposed on a shank of the eye bolt.

According to a further aspect of the present disclosure there is provided a frame for mounting a pump apparatus. The frame may be a pump frame for supporting the pump apparatus. The pump apparatus may comprise a sub-frame which is releasably mounted to the pump frame. The frame may comprise at least one latching device as claimed in any one of the preceding claims. At least one latch pin may be provided on the sub-frame. It will be understood that the mounting arrangement may be reversed such that the at least one latching device is provided on the sub-frame and the at least one latch pin may be provided on the frame.

The frame may comprise a plurality of the latching devices. The latching devices may have at least substantially the same orientation as each other. The latching devices may be arranged substantially parallel to each other. The latching apertures may be oriented in substantially the same direction, for example to receive respective latch pins provided on the pump apparatus. The latching devices may be oriented such that the latching apertures are oriented in at least substantially the same direction. For example, the latching apertures may each have an opening. The latching devices may be arranged such that the openings are oriented in substantially the same direction.

The at least one latching device may restrict or inhibit translation of the frame relative to the sub-frame. The frame and/or the sub-frame may comprise separate means for inhibiting or restricting rotational movement of the frame relative to the sub-frame. The frame and the sub-frame may, for example, comprise cooperating features for inhibiting or restricting rotational movement of the frame relative to the sub-frame. The cooperating features may, for example, comprise cooperating first and second projections provided on the frame and the sub-frame respectively. Alternatively, one of the frame and the sub-frame may be provided with a projection; and the other of the frame and the sub-frame may be provided with a recess for receiving the projection. At least one of the frame and the sub-frame may comprise a bracket or a flange for restricting rotation of the sub-frame relative to the frame. The or each anti-rotation feature may be separate from the latching device.

The or each latching device may function as a seismic restraint.

According to a further aspect of the present disclosure there is provided a pump mounting frame comprising a latch assembly. The latch assembly comprising a latching device and a latch pin,

the latching device comprising:
a body portion having at least a first projection and a latch aperture for receiving a latch pin; and
a latching member for releasably retaining the latch pin in the latch aperture, the latching member being movable between a closed position and an open position;

wherein the latch pin comprises an aperture for receiving the first projection.

The latching device may be of the type described herein. The latch pin may be of the type described herein. The latch pin may, for example, comprise an eye bolt.

The latching device may be provided on a first frame. The latch pin may be provided on a second frame. The latch assembly may be configured releasably to connect the first and second frames. For example, the second frame may be mounted on the first frame (or vice versa).

According to a further aspect of the present disclosure, there is provided a method of moving one or more pumps. The method comprises attaching one or more pumps to a pump mounting frame as described in any of the examples above and using the frame to move the one or more pumps. Moving the one or more pumps may comprise installing the one or more pumps or removing the one or more pumps for repair or replacement.

In any of the examples described above, the pump may be a vacuum pump such as a scroll pump, screw pump, roots pump, claw pump, turbomolecular pump or the like.

Within the scope of this application it is expressly intended that the various aspects, examples, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF DRAWINGS

One or more examples of the disclosure will now be described, by way of example only, with reference to the accompanying drawings.

FIG. 1 shows a mounting frame having a plurality of latching devices in accordance with an example of the present disclosure.

FIG. 2 shows an enlarged view of one of the latching devices shown in FIG. 1.

FIG. 3A shows an end elevation of a first latching device with the latching member in an open position.

FIG. 3B shows a side elevation A-A of the first latching device shown in FIG. 3A.

FIG. 3C shows a plan elevation of a first latching device shown in FIG. 3A.

FIG. 4A shows an end elevation of the first latching device with the latching member in a closed position.

FIG. 4B shows a side elevation B-B of the first latching device shown in FIG. 4A.

FIG. 4C shows a plan elevation of the first latching device shown in FIG. 4A.

FIG. 5A shows a perspective view of a latch pin.

FIG. 5B shows a side elevation of the latch pin shown in FIG. 5A.

FIG. 6 shows a side elevation of the latching member.

### DETAILED DESCRIPTION

A pump mounting frame 1 comprising a plurality of like latching devices 2-n in accordance with an example of the present disclosure is described herein with reference to the accompanying Figures. The latching devices 2-n are configured releasably to engage a respective one of a plurality of pivot pins 3-n.

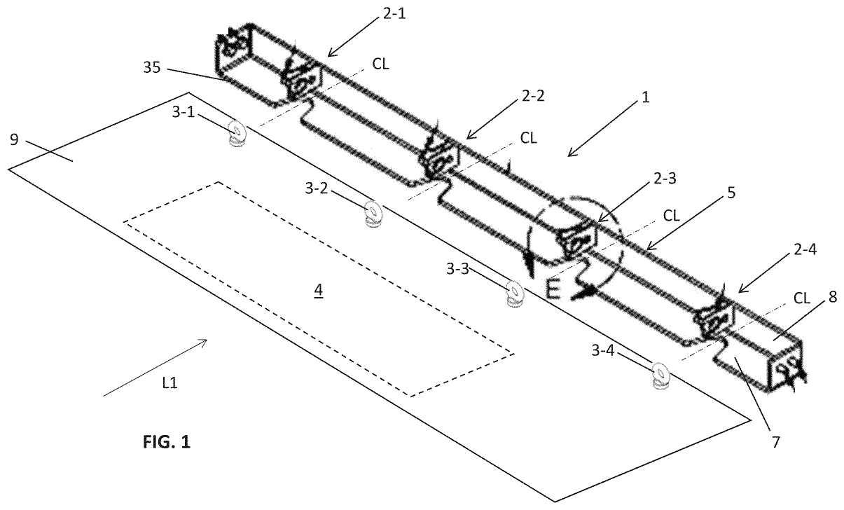

As shown in FIG. 1, the mounting frame 1 in the present example is configured releasably to mount a pump apparatus 4. The pump apparatus 4 may, for example, comprise a vacuum pump for use in a vacuum system. The latching devices 2-n function as seismic restraints for the pump apparatus 4. In use, the latching devices 2-n are configured to inhibit movement of the pump apparatus 4 in one or more directions. In the present example, the latching devices 2-n are configured to inhibit translation of the pump apparatus 4. As shown in FIG. 1, the mounting frame 1 comprises the plurality of latching devices 2-n and a frame member 5. The frame member 5 has an L-shaped profile comprising a base 7 and an upright 8. The latching devices 2-n are fastened to the frame member 5. The pump apparatus 4 in the present example comprises a sub-frame 9. The pivot pins 3-n are mounted to the sub-frame 9 of the pump apparatus 4. The latching devices 2-n and the pivot pins 3-n are referred to herein collectively as a latching assembly.

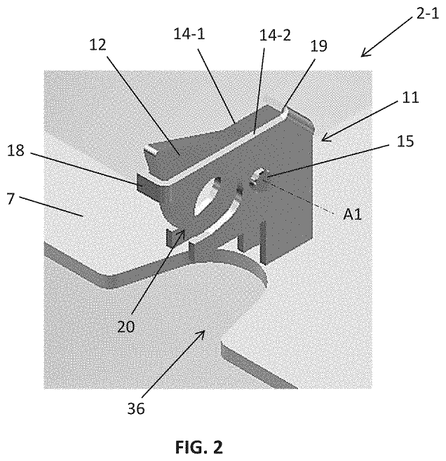

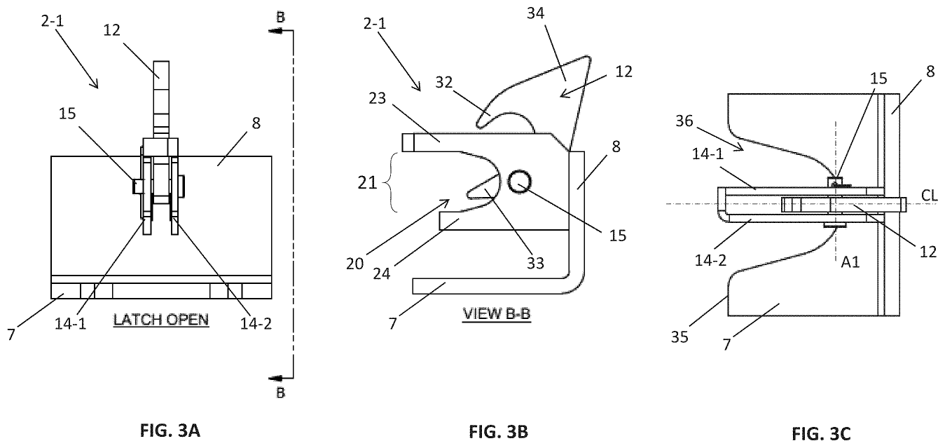

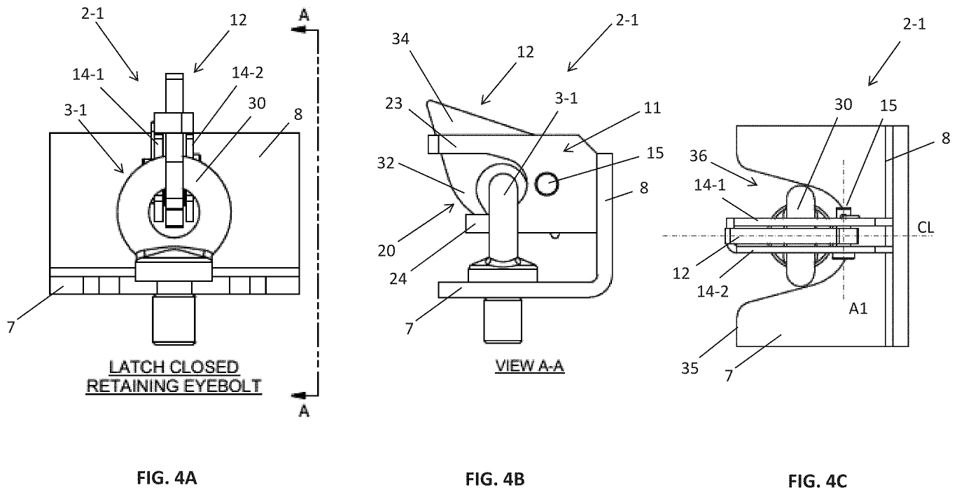

The latching devices 2-n have substantially the same configuration. For the sake of brevity, a first one of the latching devices 2-1 will now be described with reference to FIGS. 2, 3 and 4. The first latching device 2-1 is configured releasably to engage a first one of the latch pins 3-1 disposed on the sub-frame 9. The first latching device 2-1 comprises a body portion 11 and a latching member 12. The latching member 12 is pivotally mounted to the body portion 11 and, in use, pivots between an open position (shown in FIGS. 3A, 3B and 3C) and a closed position (shown in FIGS. 4A, 4B and 4C). The latching device 2-n is disposed in a latched configuration when the latching member 12 is in the closed position; and disposed in an unlatched configuration when the latching member 12 is in the open position. The body portion 11 may be fastened to the frame member 5 using a mechanical fastener (not shown), such as a rivet or a bolt; or a permanent fastener, such as a weld or bond. In the present example, the body portion 11 is fastened to the upright 8 by a weld. In a variant, the first latching device 2-1 may comprise a support member (not shown) for supporting the body portion 11. The support member may be mounted to the frame member 5.

The body portion 11 comprises first and second sidewalls 14-1, 14-2 spaced apart from each other. The body portion 11 in the present example is formed from a folded sheet metal blank. The latching member 12 is located between the first and second sidewalls 14-1, 14-2. The latching member 12 is mounted on a pivot pin 15 supported by the first and second sidewalls 14-1, 14-2. The pivot pin 15 defines a pivot axis A1 about which the latching member 12 pivots. The latching member 12 pivots about the pivot axis A1 between the closed position and the open position. The pivoting movement of the latching member 12 is constrained to a plane extending perpendicular to the pivot axis A1. The body portion 11 comprises a front stop 18 for limiting pivoting movement of the latching member 12 in a first direction; and a back stop 19 for limiting pivoting movement of the latching member 12 in a second direction. The front stop 18 and/or the back stop 19 may be formed integrally with the first and second sidewalls 14-1, 14-2. Alternatively, the front stop 18 and/or the back stop 19 may comprise a cross-member, for example in the form of a pin, extending between the first and second sidewalls 14-1, 14-2. The body portion 11 comprises a latch aperture 20 formed in the first and second sidewalls 14-1, 14-2. The latch aperture 20 comprises an opening 21 (shown in FIG. 3B) for receiving the first latch pin 3-1. In the present example, the body portion 11 comprises a generally C-shaped section having an upper projection 23 and a lower projection 24. The latch aperture 20 comprises a channel formed between the upper and lower projections 23, 24. The front stop 18 is disposed on the upper projection 23.

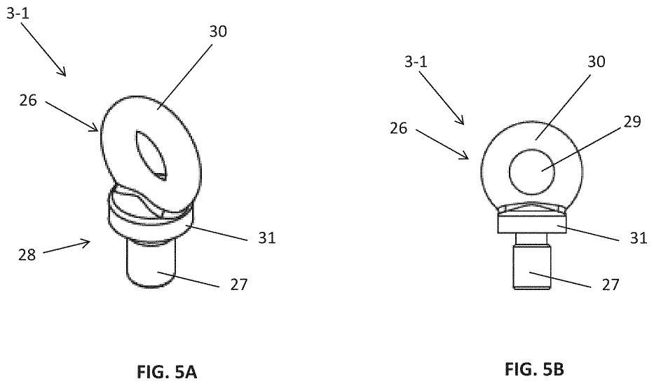

The first latching device 2-1 is configured releasably to engage the first latch pin 3-1. The first latch pin 3-1 may be in the form of a cylindrical pin. In the present example, the first latch pin 3-1 comprises an eye bolt 25, as shown in FIGS. 5A and 5B. The eye bolt 25 comprises a head portion 26, a threaded section 27 and a shank 28. In the present example, the head portion 26 is annular (or toroidal) in shape. A through hole 29 formed in the head portion 26 extends perpendicular to a longitudinal axis of the eye bolt 25. The through hole 29 is configured to receive at least a portion of the lower projection 24 of the body portion 11. By locating the lower projection 24 in the through hole 29, lateral and/or vertical movement of the first latch pin 3-1 relative to the first latching device 2-1 is reduced or inhibited. Rotational and/or lateral movement of the sub-frame 9 relative to the frame member 5 may thereby be reduced or prevented. A sector 30 of the head portion 26 locates within the latch aperture 20 and forms the first latch pin 3-1. The sector 30 is part-annular and this provides a self-centring function which may help to align the eye bolt 25 laterally and/or vertically relative to the first latching device 2-1. The eye bolt 25 is illustrated as having a head portion 26 having circular internal and external profiles. In a variant, the head portion may have an internal profile and/or an external profile comprising an ellipse or a polygon, for example a rectangle. A collar 31 is formed on the shank 28 of the eye bolt 25. The collar 31 may help to align the eye bolt 25 with the first latching device 2-1. The collar 31 may also cooperate with the base 7 to reduce or prevent lateral and/or rotational movement. The collar 31 in the present example has a circular cross-section (in a plane perpendicular to the longitudinal axis of the eye bolt 25). In a variant, the collar 31 may have a polygonal cross-section. The collar 31 may have a keyed profile, for example to cooperate with a complementary feature on the first latching device 2-1 to inhibit or limit rotation of the eye bolt 25.

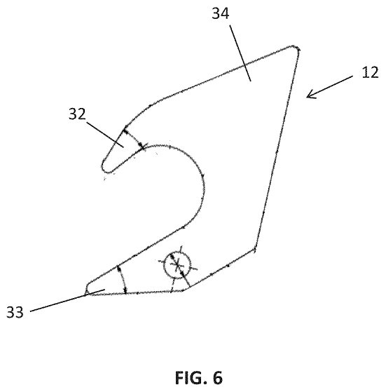

As shown in FIG. 6, the latching member 12 comprises a first arm 32, a second arm 33 and an actuating arm 34. The latching member 12 has a unitary, one-piece construction. The first and second arms 32, 33 are formed on opposing sides of the pivot axis A1 about which the latching member 12 pivots. The first arm 32 is configured at least partially to close the latch aperture 20 when the latching member 12 is in the closed position. The opening 21 of the latch aperture 20 is at least partially closed by the first arm 32 when the latching member 12 is in the closed position (as shown in FIGS. 2 and 4B). In use, the first arm 32 retains the first latch pin 3-1 in the latch aperture 20 when the latching member is in the closed position (as shown in FIG. 4B). The second arm 33 is configured at least partially to extend into the latch aperture 20 when the latching member 12 is in the open position (as shown in FIG. 3B). In use, the second arm 33 is operative to displace the first latch pin 3-1 out of the latch aperture 20 when the latching member 12 is displaced from the closed position to the open position. The displacement of the latching member 12 to the open position causes the second arm 33 to engage the first latch pin 3-1 and may apply a biasing force to bias the first latch pin 3-1 out of the latch aperture 20. The actuating arm 34 facilitates operation of the latching member 12. The actuating arm 34 is in the form of an extension located adjacent to the first arm 32 of the latching member 12. The actuating arm 34 can be engaged by an operator selectively to displace the latching member 12 to the closed position and/or the open position. In the present example, the latching member 12 is configured also to engage the front stop 18 to restrict pivoting movement of the latching member 12. A biasing means, such as a spring, could be provided to bias the latching member 12 towards the closed position or towards the open position.

As shown in FIG. 4B, the body portion 11 is mounted to the upright 8 and extends above the base 7. The first latching device 2-1 is oriented such that the latch aperture 20 is directed towards a distal edge 35 of the base 7. The pivot axis A1 is oriented substantially parallel to the distal edge 35. Thus, the latching member 12 pivots in a plane substantially perpendicular to the distal edge 35 (and the upright 8). To locate the first latch pin 3-1 in the latch aperture 20, the first latch pin 3-1 is advanced in a direction substantially perpendicular to the pivot axis A1. An arrow L1 shown in FIG. 1 illustrates the direction in which the first latch pin 3-1 is introduced into the latch aperture 20. The first latching device 2-1 comprises guide means 36 for aligning the first latch pin 3-1 with the latch aperture 20. The guide means 36 in the present example comprises a guide aperture 36 formed in the base 7. The guide aperture 36 is tapered outwardly towards the distal edge 35 of the base 7. The guide aperture 36 has a centreline CL substantially aligned with the plane in which the latching member 12 pivots. The collar 31 and the guide aperture 36 may cooperate with each other to reduce or prevent lateral and/or rotational movement of the sub-frame 9 relative to the base 7. For example, the collar 31 may engage at least one side of the guide aperture 36 to prevent lateral and/or rotational movement. In a variant, the guide means 36 may comprise a guide member for cooperating with the first latch pin 3-1. The guide member may, for example, be disposed on the base 7 and arranged to cooperate with the collar 31.

The first latching device 2-1 is operated by introducing the first latch pin 3-1 into the latch aperture 20. The first latch pin 3-1 is advanced towards the first latching device 2-1 and is introduced into the guide aperture 36. If the first latch pin 3-1 is not properly aligned, the collar 31 engages a lateral edge of the guide aperture 36 and is guided towards a centred position. The first latch pin 3-1 is thereby aligned with the first latching device 2-1 such that the lower projection 24 of the body portion 11 is aligned with the through hole 29. If the latching member 12 is in the closed position, the first latch pin 3-1 engages the convex outer surface of the first latch arm 32. The resulting force applied to the latching member 12 causes the latching member 12 to pivot about the pivot axis A1 towards the open position. The latch aperture 20 is thereby opened and the first latch pin 3-1 travels into the latch aperture 20. The lower projection 24 extends into the through hole 29 formed in the first latch pin 3-1. An operator may operate the actuating arm 34 to pivot the latching member 12 to the closed position. Alternatively, the first latch pin 3-1 may engage the second latch arm 33 and cause the latching member 12 to pivot about the pivot axis A1 to the closed position. The first latch pin 3-1 is thereby prevented from exiting the latch aperture 20. The application of a force to separate the first latching device 2-1 and the first latch pin 3-1 causes the first latch pin 3-1 to engage the concave inner surface of the first latch arm 32. The withdrawal of the first latch pin 3-1 is prevented by the first latching device 2-1. The application of a force to displace the first latch pin 3-1 towards the back of the latch aperture 20 does not affect the position of the latching member 12 since the second latch arm 33 engages the concave inner surface of the body portion 11.

It will be understood that a plurality of the latching devices 2-n are mounted on the frame member 5. In the arrangement shown in FIG. 1, there are four (4) of the latching devices 2-1, 2-2, 2-3, 2-4 mounted on the frame member 5 for engaging respective latch pins 3-1, 3-2, 3-3, 3-4. It will be understood that less than or more than four (4) latching devices 2-n may be provided. The latching devices 2-n all have substantially the same orientation to facilitate alignment of the latching devices 2-n and respective latch pins 3-n. In the arrangement shown in FIG. 1, the latching devices 2-n are disposed in a linear arrangement. A non-linear mounting arrangement is also contemplated. For example, two or more of the latching devices 2-n may be offset from each other in a longitudinal direction. In order to mount the sub-frame 9 to the frame member 5, the sub-frame 9 is advanced such that the latch pins 3-n are introduced into the latch aperture 22 of the respective latching devices 2-n. A plurality of the latching devices 2-1, 2-2, 2-3, 2-4 may operate simultaneously to secure the sub-frame 9 to the frame member 5. For example, the first and second latching devices 2-1, 2-2 may operate together to engage the first and second latch pins 3-1, 3-2 provided on the sub-frame 9.

It will be appreciated that various changes and modifications can be made to the present disclosure without departing from the scope of the present application. It will be understood that more than one of the frame members 5 described herein could be used to mount a sub-frame 7. For example, first and second frame members 5 each having at least one latching device 2-n may be provided. The first and second frame members 5 could be arranged parallel to each other, for example. The latch pins 3-n provided on the sub-frame 7 have a complementary configuration to enable mounting of the sub-frame 7.

1. A pump mounting frame comprising a latching device configured to releasably mount a pump apparatus, the latching device comprising:
a body portion having a latch aperture configured to receive a latch pin; and
a latching member configured to releasably retain the latch pin in the latch aperture, the latching member being configured to move between a closed position and an open position;
wherein the latching member comprises a first arm configured to retain the latch pin in the latch aperture when the latching member is in the closed position; and a second arm configured to bias the latch pin out of the latch aperture when the latching member is displaced from the closed position to the open position.

2. The pump mounting frame as claimed in claim 1, wherein the second arm is configured to displace the latching member to the closed position when the latch pin is inserted into the latch aperture.

3. The pump mounting frame as claimed in claim 1, wherein the second arm is configured at least partially to project into the latch aperture when the latching member is in the open position.

4. The pump mounting frame as claimed in claim 1, wherein the latching member is configured to pivot between the closed position and the open position.

5. The pump mounting frame as claimed in claim 4, wherein the latching member is configured to pivot about a pivot axis, the first and second arms being provided on opposing sides of the pivot axis.

6. The pump mounting frame as claimed in claim 1, further comprising a guide means configured to align the latch pin with the latching device.

7. A pump mounting frame comprising a latching device configured to releasably mount a pump apparatus, the latching device comprising:
a body portion having a latch aperture for receiving a latch pin;
a latching member configured to releasably retain the latch pin in the latch aperture, the latching member being configured to move between a closed position and an open position; and
a guide means configured to align the latch pin with the latching device.

8. The pump mounting frame as claimed in claim 7, further comprising a base, the guide means comprising a guide aperture.

9. The pump mounting frame as claimed in claim 8, wherein the latching member is configured to move in a plane; the guide aperture having a centreline (CL) at least substantially aligned with the plane.

10. The pump mounting frame as claimed in claim 8, wherein the guide aperture has a tapered profile.

11. The pump mounting frame as claimed in claim 7, wherein the latch pin comprises an eye bolt.

12. The pump mounting frame as claimed in claim 11, wherein the body portion comprises a projection configured to locate in an aperture formed in the eye bolt.

13. The pump mounting frame as claimed in claim 7, further comprising a plurality of the latching devices, wherein the plurality of the latching devices have at least substantially the same orientation as each other.

14. The pump mounting frame as claimed in claim 7, wherein the or each latching device functions as a seismic restraint.

15. A pump mounting frame comprising a latch assembly, the latch assembly comprising a latching device and a latch pin;
the latching device comprising:
a body portion having at least a first projection and a latch aperture configured to receive a latch pin; and
a latching member configured to releasably retain the latch pin in the latch aperture, the latching member being configured to move between a closed position and an open position;
wherein the latch pin comprises an aperture configured to receive the first projection.

16. A method of moving one or more pumps, the method comprising,
attaching the one or more pumps to the pump mounting frame as claimed in claim 15; and
using the frame to move the one or more pumps.
